(19) United States
(12) Patent Application Publication
(10) Pub. No.: US 2006/0231994 A1
(43) Pub. Date: Oct. 19, 2006

(54) Elastomeric wheel suspension

(76) Inventor: David Isrow, Detroit, MI (US)

Correspondence Address: DAVID ISROW, PMB#755, 2308 MOUNT VERNON AVENUE, ALEXANDRIA, VA, 22301, US

(21) Appl. No.: 11/108,094

(22) Filed: Apr. 18, 2005

(51) Int. Cl. B60G 11/22

(52) U.S. Cl. 267/292

(57) ABSTRACT

An elastomeric wheel suspension comprised of a vertical spindle which is mounted so as to be fixed perpendicular to the horizontal plane and having a rectangular tube base which is mounted vertically inside a rectangular tube between two elastomeric rectangular tubes which fill the inner cavities on opposite ends between the outer walls of the rectangular tube base of the vertical spindle and the inner walls of the outer rectangular tube. A horizontal shaft extends through the long sides of the rectangular tube and through the base of the vertically mounted spindle. Wheel bracket arms are affixed to the short dimensioned end of the outer rectangular tube in parallel to the long axis of the outer rectangular tube. The angle formed by the wheel bracket arms and the bottom edge of the outer rectangular tube is an obtuse angle. When a force is applied to the wheel in motion, the moment causes a corresponding rotation of the outer rectangular tube about the horizontal shaft axis. This motion is cushioned and absorbed by the two elastomeric rectangular tubes.

### CROSS-REFERENCE TO RELATED APPLICATIONS

“Not Applicable”

### STATEMENT REGARDING FEDERALLY SPONSORED RESEARCH AND DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

The field of the invention pertains to rugged wheel suspension systems which can be used in numerous utility and automotive applications. Wheel suspension systems which are rugged, scalable and low cost can be used for applications ranging from casters to automotive and trailer systems.

Other caster inventions, such as U.S. Pat. Nos. 1,745,992, 3,566,433, 4,346,498 and 4,559,669 have also utilized elastomeric cushion suspensions. Automotive suspension systems, mainly of the torsion axle type, such as U.S. Pat. Nos. 3,208,168, 3,436,069 and 5,411,287, have also utilized elastomeric suspensions. However, there currently does not exist on the market a universal elastomeric wheel suspension which can be utilized in a wide range of both small and large applications, from casters through automotive, while maintaining the same basic design. The design of this invention is intentionally basic, so as to provide a practical, cost-effective alternative for applications which do not require a sophisticated wheel suspension. The elastomeric wheel suspension can be a suitable replacement in applications which currently us an elastomeric suspension as well as those who use other cushioning and shock absorbing means such as metal springs.

### BRIEF SUMMARY OF THE INVENTION

The present invention provides an elastomeric wheel suspension which is comprised of a vertically mounted spindle having a rectangular tube base which is mounted inside a larger outer rectangular tube with two elastomeric rectangular tubes on opposing sides of the base of the vertically mounted spindle and inside the outer rectangular tube. A horizontal shaft extends through the long sides of the outer rectangular tube and through the base of the vertically mounted spindle. The outer rectangular tube is thereby able to rotate on the shaft about the horizontal axis, but only in a limited manner, being that the movement of the outer rectangular tube, caused by the impact forces of the rolling wheel, are cushioned and absorbed by the two elastomeric rectangular tubes which are positioned on opposing sides of the rectangular tube base of the vertically mounted spindle, all of which occupy the interior space of the outer rectangular tube. This configuration provides a shock resisting, cushioning effect to the vertical spindle when the vertical spindle is mounted in a fixed position and when a force is applied to short dimensioned end of the outer rectangular tube in parallel with the axis of the long dimension of the outer rectangular tube within which lies the elastomeric rectangular tubes.

Bracket arms, whose purpose are to mount a wheel, are affixed to the short dimensioned end of the outer rectangular tube. The design of the bracket arms varies depending on the application. However, the bracket arms are angled in such a manner so as to form an obtuse angle between the horizontal bottom edge of the outer rectangular tube and the bottom edge of the bracket arms. The bracket arms must be long enough to accommodate the diameter of the wheel, while allowing adequate clearance between the wheel and the outer rectangular tube.

When a force is applied to the wheel when it is in motion, as would occur due to travel over irregular surfaces, the moment due to the force acting on the area of the wheel which is in contact with a surface causes a corresponding rotation of the outer rectangular tube about the axis of the horizontal shaft. The motion of the outer rectangular tube is cushioned by the shock absorbing characteristics of the two elastomeric rectangular tubes which occupy and are confined in the opposing interior spaces between the inner walls of the rectangular tube and the outer walls of the base of the vertically mounted spindle which is mounted as a minimum so as to be fixed perpendicular to the horizontal plane.

The vertical spindle shaft is mounted to a frame member or chassis. The vertical spindle can be mounted in a fixed position, so as to allow no rotation, or in a sleeve or other rotational configuration which incorporates bearings, so as to allow rotation about the vertical shaft axis. This is determined by the function of the supported wheel (whether it should swivel or not) within the elastomeric wheel suspension system.

### BRIEF DESCRIPTION OF THE SEVERAL VIEWS OF THE DRAWING

FIG. 1 is an isometric view of the elastomeric wheel suspension having two identical bracket arms which comprise the wheel mounting system.

FIG. 2 is an isometric view of the elastomeric wheel suspension which shows an alternate wheel bracket mounting configuration having a single bracket to mount the wheel and a shorter second bracket which is connected to the wheel mounting bracket by means of a cross member.

### DETAILED DESCRIPTION OF THE INVENTION

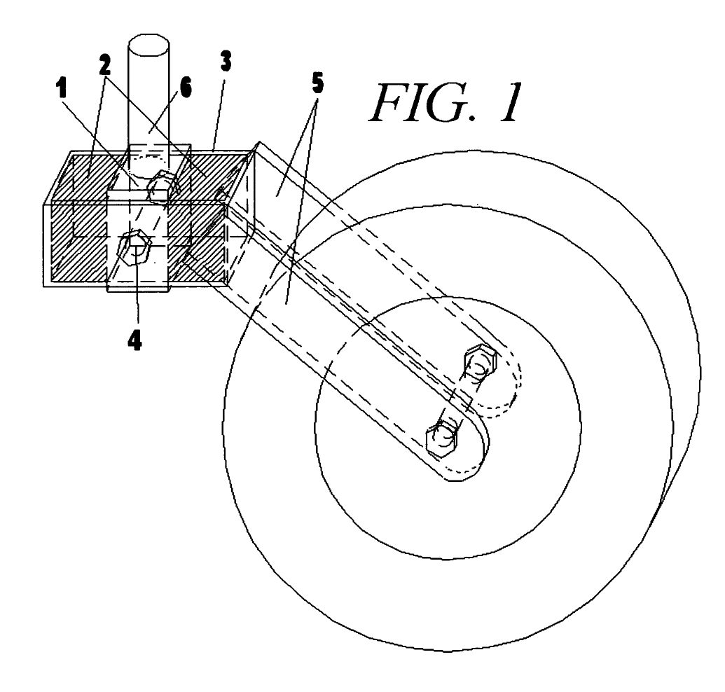

Illustrated in FIG. 1 is an isometric view of the elastomeric wheel suspension. The vertically mounted spindle 1, which has a rectangular tube base, is positioned between two elastomeric rectangular tubes 2. The vertically mounted spindle 1 and two elastomeric rectangular tubes 2 are mounted inside of a rectangular tube 3, so as to occupy the entire interior space of the rectangular tube 3. A horizontal shaft 4 extends through the long sides of the rectangular tube 3 and through the base of the vertically mounted spindle 1. The rectangular tube 3 is thereby able to rotate about the horizontal shaft 4 about the horizontal axis, but only in a limited manner, being that the movement of the rectangular tube 3, caused by the impact forces of the rolling wheel, are cushioned and absorbed by the two elastomeric rectangular tubes 2 which are positioned on opposing sides of the rectangular tube base of the vertically mounted spindle 6, all of which occupy the interior space of the rectangular tube 3. This configuration provides a shock resisting, cushioning effect when a force is applied to the short dimensioned end of the rectangular tube 3 which acts upon the elastomeric rectangular tubes 2 which are fixed between the inner walls of the rectangular tube 3 and the base of the vertically mounted spindle 1, which is mounted so as to be fixed perpendicular to the horizontal plane.

Bracket arms 5, whose purpose are to mount a wheel, are affixed to the short dimensioned end of the rectangular tube 3. The design of the bracket arms 5 will vary depending on the application. However, the bracket arms 5 are angled in such a manner so as to form an obtuse angle between the horizontal bottom edge of the rectangular tube 3 and the bottom edge of the bracket arms 5. The bracket arms 5 must be long enough to accommodate the diameter of the wheel, while allowing adequate clearance between the wheel and the rectangular tube 3.

When a force is applied to the wheel when it is in motion, as would occur due to travel over irregular surfaces, the moment realized upon the rectangular tube 3 at the point of the center of rotation of the horizontal shaft 4, due to the force acting on the area of the wheel which is in contact with the surface being transferred through the brackets 5 which are affixed to the rectangular tube 3, causes a corresponding rotation of the rectangular tube 3 about the axis of the horizontal shaft 4. The motion of the rectangular tube 3 is cushioned by the shock absorbing characteristics of the two elastomeric rectangular tubes 2 which occupy and are confined in the opposing interior spaces between the inner walls of the rectangular tube 3 and the base of the vertically mounted spindle 1 which is mounted so as to be fixed perpendicular to the horizontal plane. The rectangular tube base of the vertically mounted spindle 1 extends above the top surfaces and below the bottom surfaces of the two elastomeric rectangular tubes 2, so as to prevent the rectangular tube base of the vertically mounted spindle 1 from penetrating the interior of the elastomeric rectangular tubes 2 when a force is applied to the wheel.

The shaft of the vertically mounted spindle 1 is mounted to a frame member or chassis. The vertical shaft can be mounted in a fixed position, so as to allow no rotation about the vertical shaft axis, or in a sleeve or other rotational configuration, such as one which incorporates bearings, so as to allow rotation about the vertical shaft axis. This is determined by the function of the supported wheel (e.g., whether it should swivel or not) which comprises a component of the elastomeric wheel suspension system.

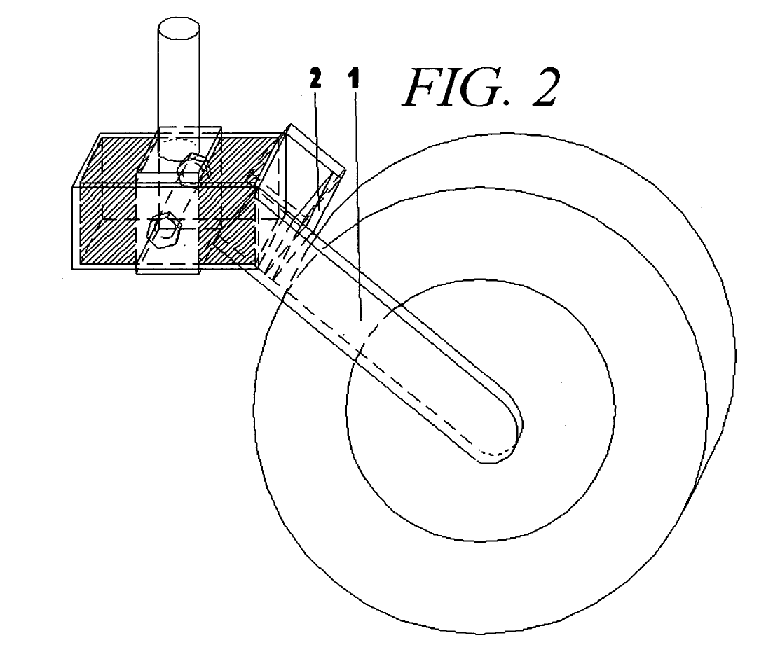

Illustrated in FIG. 2 is an isometric view of the elastomeric wheel suspension which shows an alternate wheel bracket mounting configuration having a single bracket 1 to mount the wheel and a shorter second bracket which is connected to the wheel mounting bracket by means of a cross member 2.

I claim:

1. An elastomeric wheel suspension comprising:
A vertical spindle having a rectangular tube base mounted inside a separate larger outer rectangular tube, with the vertical spindle extending above its rectangular tube base and the outer rectangular tube. A horizontal shaft extends through the long sides of the outer rectangular tube and through the interior rectangular tube base of the vertical spindle. The two interior cavities between the outer walls of the rectangular tube base of the vertical spindle and the inner walls of the outer rectangular tube are occupied by two elastomeric rectangular tubes. A single bracket arm or two bracket arms are affixed to one of the short dimensioned sides of the outer rectangular tube in parallel to the axis of the long dimensioned sides of the outer rectangular tube. The angle formed by the bracket arm or arms and the bottom edge of the outer rectangular tube is an obtuse angle. A spindle is mounted perpendicularly to the opposite end of the bracket arm or arms for the purpose of mounting a wheel.
